(19) United States
(12) Patent Application Publication
(10) Pub. No.: US 2011/0084557 A1
(43) Pub. Date: Apr. 14, 2011

(54) MAXIMUM POWER POINT TRACKING SOLAR POWER SYSTEM

(75) Inventors: Chih-Chan GER, Jhongli City (TW); Chia-Kun CHEN, Jhongli City (TW)

(73) Assignee: AMPOWER TECHNOLOGY CO., LTD., Jhongli City (TW)

(21) Appl. No.: 12/697,354

(22) Filed: Feb. 1, 2010

(30) Foreign Application Priority Data
Oct. 12, 2009 (CN) 200920312250.3

(51) Int. Cl. H02J 1/10

(52) U.S. Cl. 307/82

(57) ABSTRACT

A solar power system includes a number of solar panels, a bus, and a DC-AC inverter. Each of the solar panels includes a plurality of photovoltaic chips and a DC-DC converter wherein the photovoltaic chips are serially connected and configured for converting sunlight energy into electrical power. The DC-DC converter is configured for converting the voltage generated by the photovoltaic chips of each solar panel to a common voltage value. The bus electrically connects to the DC-DC converters for receiving the electrical power generate from the solar panels. The DC-AC inverter connects to the bus to invert the DC voltage of the bus into AC voltage.

### BACKGROUND

1. Technical Field

The present disclosure relates to solar power systems, and particularly, to a maximum power point tracking (MPPT) solar power system.

2. Description of Related Art

Solar panels are typically connected in parallel and constitute a solar power system for providing power to a load. However, as each of the solar panels consists of different numbers of photovoltaic chip, the solar panels may have different output voltages. As such, in use, some solar panels may operate in a full load state while other solar panels are idle.

Therefore, a solar power system which can overcome the above-described problems is desirable.

### BRIEF DESCRIPTION OF THE DRAWINGS

FIG. 1 is a schematic view of a solar power system in accordance with an exemplary embodiment.

FIG. 2 is a circuit diagram of one embodiment of a DC-DC convertor of the solar power system of the FIG. 1.

FIG. 3 is a diagram showing one embodiment of load lines of solar panels of the solar power system of the FIG. 1.

### DETAILED DESCRIPTION

Embodiments of the disclosure are now described in detail with reference to the drawings.

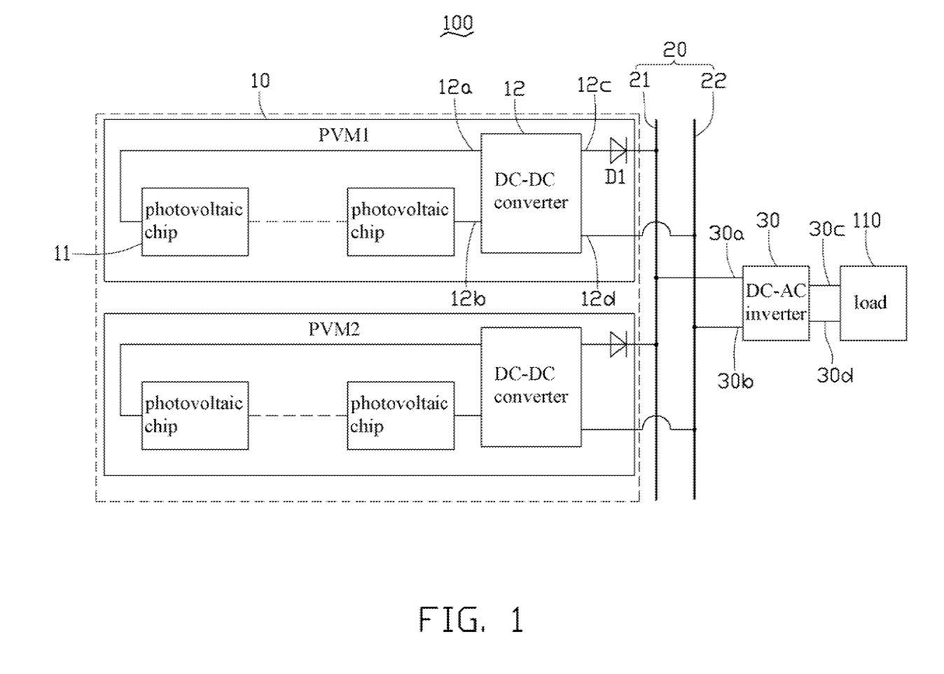

Referring to FIG. 1, a solar power system 100, according to an exemplary embodiment, is configured for providing power to a load 110. The solar power system 100 includes a number of solar panels 10, a bus 20, and a direct current (DC)-alternating current (AC) inverter 30.

The solar panels 10 are connected in parallel, and each of the solar panels 10 includes a number of photovoltaic chips 11, a DC-DC converter 12, and a first diode D1. In one non-limiting embodiment, the solar power system 100 includes two solar panels 10: a first solar panel PVM1 and a second solar panel PVM2, where the first solar panel PVM1 and the second solar panel PVM2 consist of different number of photovoltaic chips 11. However, it can be understood that, the first solar panel PVM1 and the second solar panel PVM2 also can consist of same number of photovoltaic chips 11.

In each solar panel 10, the photovoltaic chips 11 are connected in series, and configured for converting sunlight energy into electrical power. The DC-DC converter 12 includes a first input terminal 12a, a second input terminal 12b, a first output terminal 12c, and a second output terminal 12d. The first input terminal 12a and the second terminal input 12b are coupled to the two output electrodes of the photovoltaic chips 11. The DC-DC converter 12 is configured for converting the output voltage of the photovoltaic chips 11 into a common voltage value, and the output voltage of a DC-DC converter 12 is approximately proportional to the output current of the DC-DC converter 12. The first diode D1 includes an anode coupled to the first output terminal 12c and a cathode. The first diode D1 is configured for protecting the current draw back from bus 20 to DC-DC converter 12 if the DC-DC converter 12 failure.

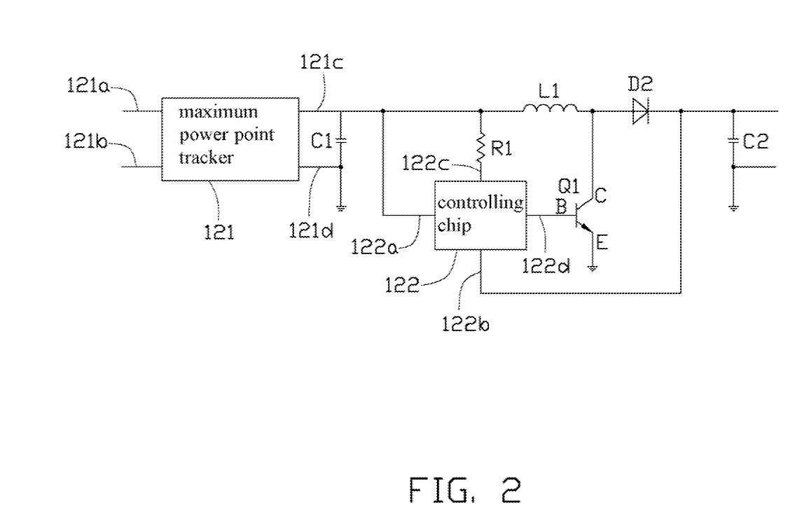

Further referring to FIG. 2, the DC-DC converter 12 includes a maximum power point tracker (MPPT) 121, a first capacitor C1, a controlling chip 122, a resistor R1, an inductor L1, a transistor Q1, a second diode D2, and a second capacitor C2.

The MPPT 121 includes a first input terminal 121a, a second input terminal 121b, a first output terminal 121c, and a second output terminal 121d. The first input terminal 121a and the second input terminal 121b of the MPPT 121 function as the first input terminal 12a and the second input terminal 12b of the DC-DC converter 12 respectively, and the second output terminal 121d is grounded. The first capacitor C1 is coupled between the first output terminal 121c and the second output terminal 121d. The controlling chip 122 includes a first input terminal 122a, a second input terminal 122b, a first output terminal 122c, and a second output terminal 122d. The first input terminal 122a is coupled to the first output terminal 121c. The resistor R1 is coupled between the first output terminal 121c and the first output terminal 122c. The transistor Q1 includes a collector C, an emitter E, and a base B used to control connection and disconnection between the collector C and the emitter E. The base B is coupled to the second output terminal 122d and the emitter E is grounded. The inductor L1 is coupled between the first output terminal 121c and the collector C. The second diode D2 includes an anode coupled to the collector C and a cathode coupled to the second input terminal 122b. The second capacitor C2 includes a first terminal coupled to the cathode of the second diode D2 and a second terminal is grounded. The anode and cathode of the second capacitor C2 function as the first output terminal 12c and the second output terminal 12d.

The MPPT 121 is configured for tracking the maximum power point of the photovoltaic chips 11 in order to present the optimal load to the solar panels 10. The inductor L1, the transistor Q1, and the second diode D2 form an amplifying circuit structured and arranged for amplifying the voltage generated by the MPPT 121. The controlling chip 122 acquires the amplified voltage and adjusts the voltage amplification factor of the amplifying circuit.

The bus 20 includes a live wire 21 and a null line 22. The first output terminal 12c and the second output terminal 12d are coupled to the live wire 21 and the null line 22 respectively. The bus 20 is configured for receiving the electrical power generate from the solar panels 10.

The DC-AC inverter 30 includes a first input terminal 30a, a second input terminal 30b, a first output terminal 30c, and a second output terminal 30d. The first terminal 30a and the second input terminal 30b are coupled to the live wire 21 and the null line 22 respectively. The load 110 is electrically coupled to the first output terminal 30c and the second output terminal 30d. The DC-AC inverter 30 is configured for inverting the DC voltage from the bus 20 into AC voltage.

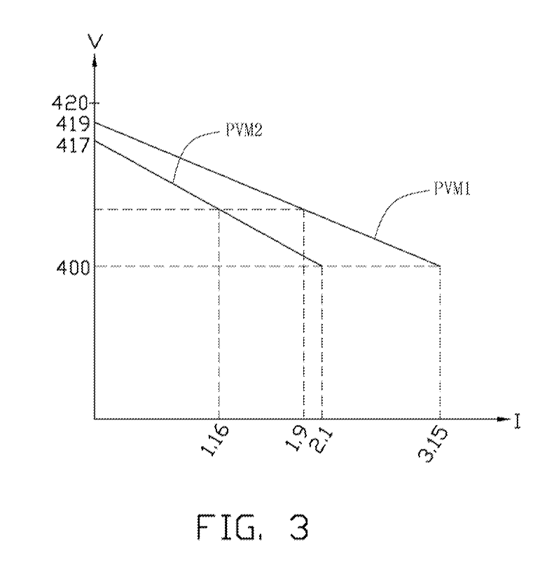

Further referring to the FIG. 3, regarding the load lines of the first solar panel PVM1 and the first solar panel PVM2, and the slope of the load lines of the first solar panel PVM1 and the first solar panel PVM2 are approximately. In this embodiment, the maximum power of the first solar panel PVM1 generated at one time is 1257 w, and the output voltage V_{PVM1} and the output current I_{PVM1} satisfy the formula:

V_{PVM1}=−6I_{PVM1}+419 (1)

In FIG. 3, the maximum power of the second solar panel PVM2 generated at one time is 834 w, and the output voltage V_{PVM2} and the output current I_{PVM2} satisfy the formula:

V_{PVM2}=−8.1I_{PVM2}+417 (2)

When the load 110 of which the power consumption is 1257 w is electrically coupled to the solar power system 100, the first solar panel PVM1 and the second solar panel PVM2 satisfy the formulas:

V_{PVM1}*I_{PVM1}+V_{PVM2}*I_{PVM2}=1257 (3)

V_{PVM1}=V_{PVM2} (4)

According to the formulas (1)-(4), I_{PVM1}=1.91 A, I_{PVM2}=1.17 A, V_{PVM1}=V_{PVM2}=407.52V; and P_{PVM1}=778.4 W, P_{PVM2}=476.8.4 W; wherein the P_{PVM1} and P_{PVM2} represent power consumption of the first solar panel PVM1 and the second solar panel PVM2 respectively.

Subsequent to the DC-DC converters 12 conversion of the voltage of the first solar panel PVM1 and the second solar panel PVM2 to a common voltage value, (e.g., about 407.52v), the power consumption of the first solar panel PVM1 and the second solar panel PVM2 are relatively averaged. In this embodiment, in order to simplify the calculation process, the relationship between the output voltage V_{PVM1} and the output current I_{PVM1} of the first solar panel PVM1 and the relationship between the output voltage V_{PVM2} and the output current I_{PVM2} of the second solar panel PVM2 are considered to be linear.

It will be understood that the above particular embodiments and methods are shown and described by way of illustration only. The principles and the features of the present disclosure may be employed in various and numerous embodiment thereof without departing from the scope of the disclosure as claimed. The above-described embodiments illustrate the scope of the disclosure but do not restrict the scope of the disclosure.

What is claimed is:

1. A solar power system, comprising:
a plurality of solar panels, each of the solar panels comprising a plurality of photovoltaic chips and a direct current (DC)-DC converter, wherein the photovoltaic chips are serially connected and configured for converting sunlight energy into electrical power, the DC-DC converter is configured for converting the voltage generated by the photovoltaic chips of each solar panel to a common voltage value;
a bus electrically connecting to the DC-DC converters for receiving the electrical power generate from the solar panels; and
a DC-alternating current (AC) inverter connecting to the bus to invert the DC voltage of the bus into AC voltage.

2. The solar power system in claim 1, further comprising a first diode coupled between the DC-DC converter and the bus.

3. The solar power system in claim 2, wherein the bus comprising a live wire and a null line, the anode of the first diode is coupled to the DC-DC converter and the cathode is coupled to the live wire.

4. The solar power system in claim 1, wherein the DC-DC converter comprising a maximum power point tracker (MPPT), the MPPT is configured for tracking the maximum power generated by the solar panels.

5. The solar power system in claim 4, wherein the MPPT comprising a first input terminal, a second input terminal, a first output terminal, and a second output terminal; the first input terminal and second input terminal are coupled to the photovoltaic chips, the second output terminal is grounded.

6. The solar power system in claim 5, wherein the DC-DC converter further comprising a first capacitor, a controlling chip, a resistor, an inductor, a transistor, a second diode, and a second capacitor; the first capacitor is coupled between the first output terminal and a second output terminal, the controlling chip comprising a first input terminal coupled to the first output terminal of the MPPT, a second input terminal, a first output terminal coupled to the first output terminal of the MPPT via the resistor, and a second output terminal; the transistor comprising a base coupled to the second output terminal of the controlling chip, a emitter is ground, and a collector; the inductor is coupled between the first output terminal of the MPPT and the collector; the second diode comprising an anode coupled to the collector and a cathode coupled to the second input terminal of the controlling chip; the second capacitor comprising a first terminal coupled to the cathode and a second terminal grounded.

7. The solar power system in claim 1, wherein the output voltage of a DC-DC converter is approximately proportional to the output current of the DC-DC converter.

8. The solar power system in claim 1, wherein the slope of the load lines of the solar panels are approximately.
